(19) United States
(12) Patent Application Publication
(10) Pub. No.: US 2010/0077693 A1
(43) Pub. Date: Apr. 1, 2010

(54) Deployable light structure capable of being rigidified after deployment, its production process and its application to equipping a spacecraft

(75) Inventor: Rene Jean Cheynet de Beaupre, Castanet Tolosan (FR)

Correspondence Address: PATZIK, FRANK & SAMOTNY LTD., 150 SOUTH WACKER DRIVE, SUITE 1500, CHICAGO, IL, 60606, US

(73) Assignee: Astrium SAS, Paris (FR)

(21) Appl. No.: 11/993,767

(22) PCT Filed: Jun. 13, 2006
(86) PCT No.: PCT/FR06/01333

§ 371 Date: Dec. 21, 2007

(30) Foreign Application Priority Data
Jun. 22, 2005 (FR) 05/06,342

(51) Int. Cl. E04H 12/02; B64G 1/22

(52) U.S. Cl. 52/645; 52/745.19; 244/159.4

(57) ABSTRACT

The invention concerns a structure comprising a rigging (1-2) consisting of at least one flexible rope (1, 2) impregnated with a hardening substance, with controllable hardening, designed to rigidify at least one rope after it has been deployed and extended. The structure may comprise at least one rigging mesh, whereof at least one flexible rope (1, 2) is impregnated with the hardening substance and bound to itself and/or to another rope of the rigging by at least one bond (6). Said structure is independent of any means of deployment, but may also comprise a deploying device (3) independent of the rigging and extending the ropes (1, 2) of the structure and maintaining them taut while the hardening material is cured. The invention is in particular applicable to deployable structures capable of being rigidified on board space crafts.

This invention concerns a deployable light structure capable of being rigidified after deployment, which can be very simple but also potentially complex, as well as its production process and, in an application for which the structure according to the invention is of particular interest to the applicant, its application to equipping spacecraft, for example and in a nonlimiting manner, for creating rigidifying connecting rods for holding solar or radiator panels in a deployed position with respect to the body of the spacecraft, for keeping a component, for example an external component, in a given position and with a given distance with respect to the body of the spacecraft, or for keeping a surface, for example a flat surface such as a solar screen or a complex surface such as an antenna reflector, extended.

In general, the invention proposes a method of creating a deployable light structure capable of being rigidified after deployment, which can be deployed manually or using suitable means of deployment after storage at reduced volume, after which the structure can be rigidified, it being possible for the optional means of deployment to be removed or retracted following their operation, such as an erection tool or machine-tool, which is subsequently dismantled and/or moved.

The structure and the process according to the invention can be used for creating any structure which has to be transported and/or stored at reduced volume, then deployed and rigidified in situ.

In the space field, spacecraft such as artificial satellites and exploration or interplanetary probes have increasingly complex bodies and equipment requiring structures which are both light and of reduced volume to minimize the mass and volume, when launching the spacecraft, and stable to maintain precise relative positioning, in particular of on-board measuring instruments, with respect to the body of the spacecraft.

The invention proposes simultaneously a structure of the type described above and a process for producing this structure, which are both inexpensive in terms of potentially usable materials and techniques and very easy to implement.

Deployable light structures of the state of the art are of three main types.

Those of the first type are mechanical structures made up of mutually hinged rigid parts; these structures can also comprise stays. Structures of this type are generally deployed by the action of springs, but they can also be deployed, extended or opened by inflation of at least one gas bag, it being possible for the springs and gas bags to conserve their elastic energy or their inflation pressure for the deployed structures to keep their shape, as known in U.S. Pat. No. 5,990,851.

Deployable light structures of the second type are flexible structures implementing elastic parts, which are usually folded back under stresses and deploy without external assistance as soon as the stresses are released, for example by opening a container in which they are stored at reduced volume, for example in the folded, rolled or collapsed state. They can be of very simple constitution, of the type comprising a tape, which unrolls from a reel and of which a certain unrolled length is kept taut through the conformation of the tape and of the constitutive material, for example of the tape measure type. But they can also be of more complex constitution and comprise, for example, an assembly of elastic ribs, such as those known through WO 03/06 2565.

Deployable light structures of the third type are generally inflatable structures implementing gas bags, such as those known through WO 02/09 79 17, and possibly covered with materials hardening after extension, such as known through U.S. Pat. No. 4,755,819 and WO 2004/07 24 13, or comprising such materials hardening after extension, such as those known through U.S. Pat. No. 5,579,609 and U.S. Pat. No. 6,735,920, when long-term shape stability is sought.

The state-of-the-art embodiments closest to the invention, namely inflatable structures comprising materials hardening after extension or covered with such materials, have major drawbacks.

After deployment, the volumes of these structures remain of simple shapes or are assemblies of simple shapes, such as tubes and volumes similar to spheres or portions of spheres.

Furthermore, the necessary cohesion between the inflatable structure and the hardening element or elements makes the unit complex to fabricate. In particular, in U.S. Pat. No. 5,579,609, the jacket of the inflatable structure remains solidly connected to the sheaths of the hardening elements, such that the deployment device implementing an inflatable structure is not independent of the deployable light structure capable of being rigidified.

Besides, assembly of the unit is made even more complex if at least one opposing gas bag is required to give the deployed structure its final shape and confine the hardening material.

Moreover, with such known structures, a sequence of an inflation followed by a deflation and a folding back of the structure, if these operations are indeed possible, can call into question the relative positions of the different elements of the structure and the cohesion of the unit, which is unacceptable for many applications.

Finally, in the case of using hardening fabrics to give shape stability, the rigidity of the overall structure after hardening of such fabrics and deflation of the gas bag requires the use of reinforcing pieces, in particular, to prevent buckling of the skin of such a structure composed of hardened fabrics. Besides, with a single thickness of fabric, it is impossible to create structures of large dimensions, which can only be created using more complex deployable structures.

The problem forming the basis of the invention is to overcome the drawbacks, referred to above, of deployable light structures of the third type described above and the object of the invention is to propose a deployable light structure capable of being rigidified after deployment, which satisfies the various practical requirements better than the known embodiments described above, particularly in that the invention allows easy, economic creation of deployable light structures as simple as a rigidifying connecting rod and as complex as a three-dimensional lattice for creating load-bearing beams and columns.

For this purpose, the deployable light structure capable of being rigidified after deployment according to the invention is characterized in that it comprises a rigging composed of at least one flexible rope impregnated with a hardening material, whose hardening can be controlled, designed to rigidify said at least one rope after its deployment and extension, and in that it is independent of any means of deployment designed to extend at least one rope of the structure and to keep it taut during hardening of said hardening material. The terms “any means of deployment” concern as much a manual deployment as an auxiliary deployment device integrated or not integrated into the structure, but of which the latter is independent in that at least each rope of the structure is independent of the means of deployment.

Thus, in the simplest cases, the structure comprises a rigging, which can be composed of one single rope or several ropes interlinked either directly or through at least one linkage part of said structure, whilst in cases of more complex structures, this structure comprises advantageously at least one rigging mesh, of which at least one flexible rope is impregnated with said hardening material and linked to itself and/or to at least one other rope of said rigging by at least one link.

Holding of the rope or ropes and/or of the rigging mesh or meshes in the deployed state can be ensured manually during rigidifying, but preferably for many applications, including the space applications referred to above, the structure also and advantageously comprises at least one deployment device independent of the rigging and designed to extend at least one rope of the structure and keep it taut during hardening of said hardening material.

In the latter case and when the structure comprises at least one rigging mesh, the extension system is designed to deploy then keep said rigging mesh taut during its rigidification.

The rigging can be advantageously and easily created from all known fiber materials and, in particular, the rigging is composed of at least one type of fiber selected from mineral, such as glass or carbon, and synthetic or organic, such as polyester or polyamide, and aramid and artificial fibers.

In a well-known manner in the aerospace industry, at least one rope of the rigging can be a composite rope comprising fiber rovings pre-impregnated with a resin capable of being rigidified.

Similarly, concerning the structure of the ropes of the rigging, at least one of the ropes can be manufactured with a well-known structure and, in particular, be one of the following types: single braided rope, laid rope, rope with a core enclosed in a sheath, rope with a braided core, rope with parallel fibers or strands and/or rope with a woven or braided or laid sheath.

Each rope of the rigging can therefore be a rope available from suppliers or be manufactured to order on a conventional rigging weaving machine with a specific fiber or a combination of specific fibers. Impregnation with hardening material, in particular a resin, can only be subsequently performed, especially if the rigging is of the woven or braided type, which allows the meshes to be opened to allow better penetration of the resin into the core.

Moreover, at least one rope of the rigging, but preferably each rope, is advantageously enclosed in an impervious sheath of at least one of the following types: a continuous sheath made of synthetic, preferably thermosetting, material and a sheath made of a sheet of synthetic material wrapped around said rope, then glued or welded to itself.

Such a sheath can be easily manufactured and allows the use of more or less liquid resins, which could be dried either by manipulation or by remaining for a period in the vacuum of space or, more generally, in the ambient atmosphere.

Concerning the hardening material, this reacts with at least one of the hardening agents selected from the group comprising light radiation in visible or ultraviolet light, thermal radiation, temperature, humidity, ambient atmosphere and vacuum.

In a particular form of embodiment, at least one rope of the rigging incorporates a heating element, preferably a heating filament, whose heating controls the hardening of the hardening material impregnating said rope.

In other embodiments, at least one rope of the rigging, and preferably each rope, incorporates an impervious sheath transparent to a hardening agent controlling the hardening of the hardening material impregnating said rope, in particular, an impervious sheath made of synthetic material transparent to ultraviolet radiation.

Moreover, the imperviousness thereby ensured with respect to the surrounding environment allows extension of the expiration time of the rope, which could be reduced to several months for a rope impregnated with resin not enclosed in an impervious sheath and stored in the open air or in the ambient atmosphere without any special precautions.

Concerning the means of attaching at least one rope to itself or to other ropes of the rigging, each link can be composed of at least one of the following means: a knot, a tie, a clamping collar, by gripping or binding of two sections of the rope at their linkage location.

It will be noted that an advantageous effect of gripping and binding ropes at their linkage locations is that these means rigidify the linkage location after hardening of these ropes.

Similarly, concerning the fixing of a structure on a base or the fixing of objects on a structure, at least one rope of the rigging, and preferably each of them, can be simply attached at one end by at least one of the following means: a loop, a knot and by gripping.

Another advantage of the structure according to the invention is that it can be optimized by suitable selection of the rope or ropes forming the rigging. The cross section of at least one rope of said rigging can effectively be adjusted in shape and/or dimension according to the desired properties of the rigidified structure, in particular, its mass, its spatial requirement and its stiffness.

Advantageously, the structure according to the invention comprises additionally a protective jacket enclosing said rigging before its deployment and deployed simultaneously with said rigging, said protective jacket being independent from the deployment device, if need be.

More advantageously, the protective jacket can ensure at least one of the following functions: thermal control, anti-meteorite, anti-debris and anti-radiation protection.

Furthermore, and for the case in which the hardening agent of the hardening material impregnating the rope or ropes of the rigging is light radiation, the protective jacket is advantageously transparent at least within the spectral range of solar radiation acting as hardening agent.

Concerning the deployment device, this can be of any suitable type and, in particular, can comprise at least one of the following means: an inflatable gas bag, a pressure cylinder, an elastic expander, a hinged mechanical device and a stay.

Advantageously in addition, in order that deployment of the structure is not excessively sudden and does not therefore damage the structure, the latter can incorporate additionally a braking system designed to limit at least the deployment speed during deployment.

To protect the structure against any untimely hardening and any possible mechanical damage before its deployment, the whole of the rigging, before its deployment, and, if required, the deployment device, the protective jacket, the braking system, and possibly also at least one hardening agent control and/or production device as well as at least one thermal control device, can be housed in a container, in which said rigging is arranged in the rolled, folded or collapsed state.

In this case, the container preferably comprises at least one cover, which can form a support erected above at least one base trunk of the container, when the structure is deployed and rigidified.

This invention also concerns applications of the structure according to the invention and as described above, these applications being characterized in that this structure is installed aboard a spacecraft.

As an application for which the invention appears to be of particular interest to the applicant, said rigidified structure forms at least one rigidifying connecting rod of a moveable solar or radiator panel of a spacecraft, said structure comprising at least one rope attached at one end to the body of said spacecraft and at the other end to a fixed point of said moveable panel, said fixed point being chosen such that the vibration mode frequencies of said panel, kept deployed with respect to the body of the spacecraft, when said rope is rigidified to form a rigidifying connecting rod, are greater than a desired frequency threshold, said panel being moveable with respect to the body of the spacecraft between a folded back position, in which the panel extends substantially along the body of said spacecraft and in which said rope is protected from any hardening agent likely to cause hardening of said impregnating hardening material, and a deployed position, in which said panel is moved away from said body of the spacecraft by at least one actuator, and that the rope, after its deployment through deployment of said panel, rigidifies under the effect of at least one hardening agent, such as natural solar radiation, heating produced by a dedicated heating device internal or external to the rope or a dedicated lighting device emitting light to cause rigidifying of the hardening material, particularly a polymerizable resin reactive to monochromatic light.

This invention also refers to a process for producing a deployable light structure capable of being rigidified after deployment as described above, the process being characterized in that it comprises at least the steps consisting in:
impregnating at least one rope of a structural rigging with a hardening material, whose hardening can be controlled,
creating a rigging structure of a shape suitable for providing the deployed and rigidified structure desired, preferably using a template of the desired shape, by choosing the number, the dimensions and shapes and the relative positions of the ropes of said rigging, if necessary, of the rigging mesh or meshes,
extending said rigging into the desired shape before its hardening, and
keeping said rigging taut during its hardening by exposure of said taut rigging to at least one hardening agent for said hardening material impregnating the ropes.

Other advantages and characteristics of the invention will emerge from the description, given below on a nonlimiting basis, of exemplary embodiments described with reference to the appended drawings in which:

FIG. 1 is a partial front and a partial cross-sectional view of a first example of a structure according to the invention, which is a three-dimensional lattice structure shown deployed and erected,

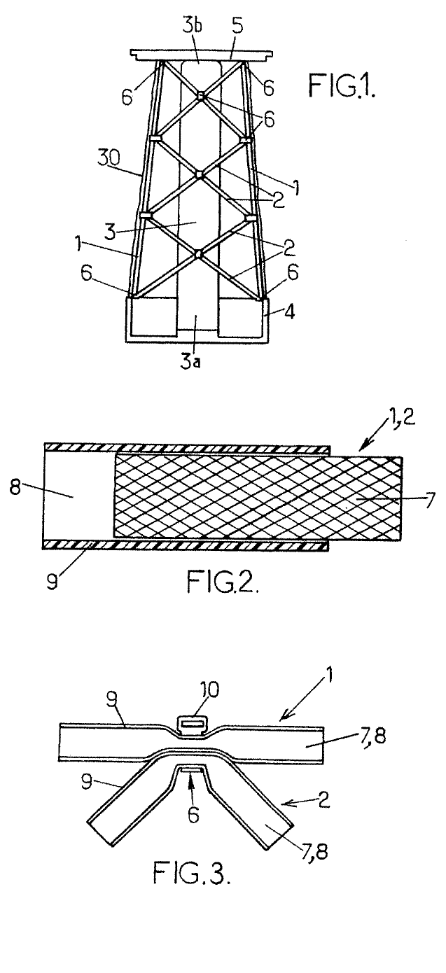

FIG. 2 is a partial lateral elevation and a partial cross-sectional diagrammatic view of an example of a section of rope impregnated with a hardening material, which can be used to form the latticed rigging of the structure in FIG. 1,

FIG. 3 is a cross-sectional diagrammatic view of a link between two ropes, for example as shown in FIG. 2, and belonging, for example, to the latticed rigging of the structure in FIG. 1,

FIG. 4 is a perspective view of a second example of a structure according to the invention, arranged as a tripod when it is deployed,

FIG. 5 is a partial perspective view of a third example of a structure according to the invention forming a three-dimensional lattice beam of triangular cross section, when it is deployed and rigidified, composed of longitudinal ropes or inclined cross-members and rigid ribs or frames,

FIG. 6 is a fourth example of a structure according to the invention forming a three-dimensional lattice tower or jib with a top section inclined to the vertical, when the structure is deployed and rigidified,

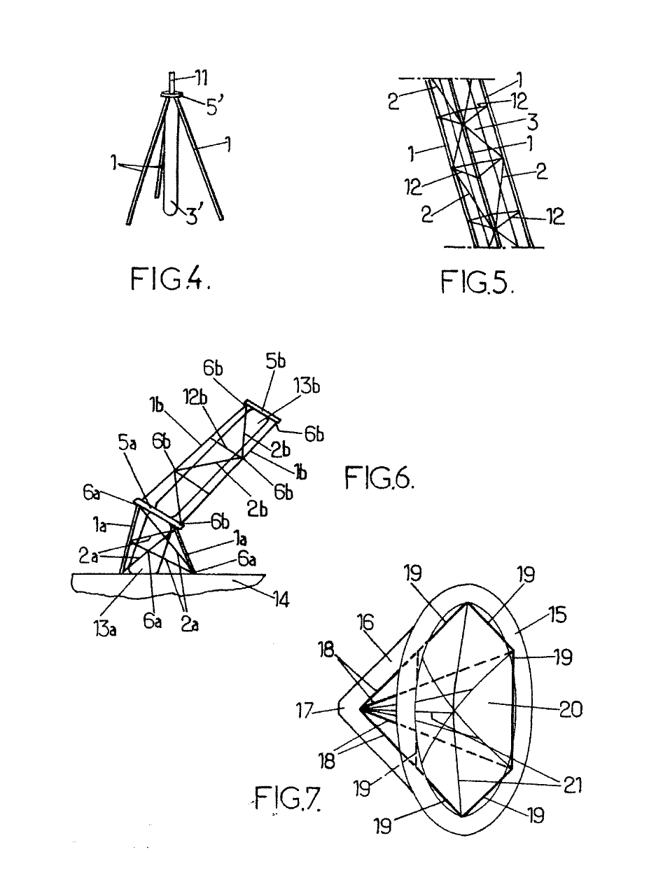

FIG. 7 is a fifth example of a structure according to the invention, which ensures the deployment and the extension of a shell, for example a reflecting shell, when the structure is deployed and rigidified, and

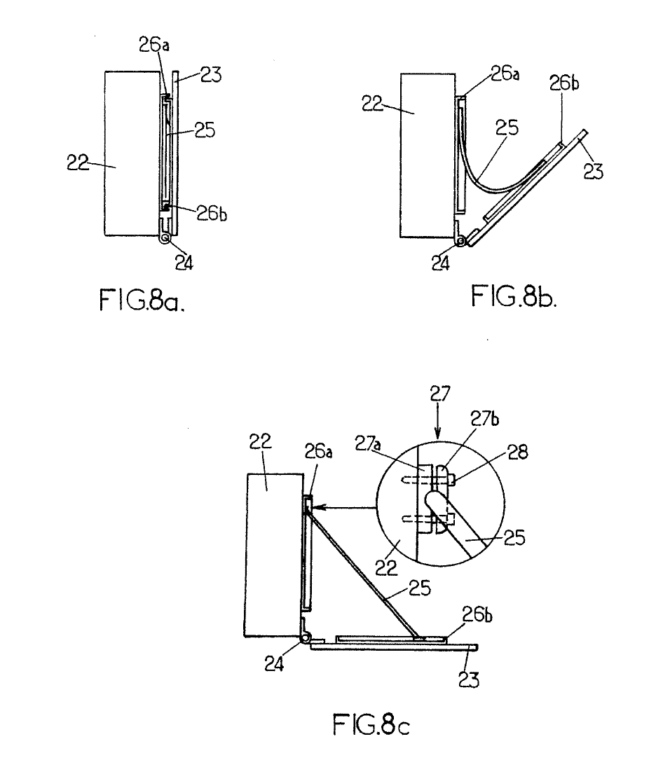

FIGS. 8a, 8b and 8c show a deployment sequence of a sixth example of a structure according to the invention forming a rigidified bracing connecting rod of a deployable satellite panel, when the structure is deployed and rigidified, with a circled detail of FIG. 8c showing the fixing of one end of the connecting rod.

The first example of the deployed, rigidified light structure according to FIG. 1 is a tower in the form of a truncated pyramid of rectangular quadrilateral-based cross section, whose uprights erected along the edges at the four apexes of the cross section, on the one hand, and whose inclined, intersecting cross-members connected to the uprights, on the other hand, are all composed of initially flexible ropes 1, 2 impregnated with a hardening material, such as a polymerizable resin, the ropes having been rigidified by a hardening agent of the impregnating resin after the structure has been deployed in the position shown in FIG. 1 by a deployment device essentially formed, in this example, of an impervious flexible gas bag 3, which can be inflated by a gas, for example compressed air, the gas bag 3 having, in the inflated state, the overall shape of an elongated cylinder of approximately circular cross section, fixed by its bottom end 3a to a base box 4 supporting the structure and through which the gas bag 3 can be inflated or, as an alternative embodiment, arranged in a trunk, as shown diagrammatically in FIG. 1, and containing a gas tank (not shown) for inflating the gas bag 3, whose top end 3b bears against a platform 5 supported by the deployed rigidified structure and forming, in this example, the cover of the trunk or base box 4, in which the structure unit is housed with its latticed rigging, formed by the assembly of ropes 1 of the uprights and ropes 2 of the cross-members, in the folded, rolled or collapsed state, with also the gas bag 3 deflated and folded back on itself and with the inflation gas bottle, if need be.

The ropes of the cross-member 2 are linked to one another at their crossing points and to the upright ropes 1 at the ends of the cross-members by links 6, which can be created in different ways, by knots or ties or again by means of gripping or binding two adjacent sections of two ropes 1 and/or 2 using a clamping collar 10, as described below with reference to FIG. 3.

Similarly, the bottom ends of both the upright ropes 1 and the bottom cross-member ropes 2 are fixed to the base box 4, and the top ends of the upright ropes 1 and the top cross-member ropes 2 are fixed to the platform 5 by other links 6, also formed by knots, loops or by means of gripping, in particular.

The combined upright ropes 1 and cross-member ropes 2 form a latticed rigging, of which all the ropes are initially flexible and impregnated, for example, with a polymerizable resin, hardening of which can be controlled and commanded after deployment of the structure by inflating the gas bag 3 to cause rigidification of the structure in the deployed state by rigidifying the various ropes 1 and 2.

To ensure excellent rigidification of the deployed structure, the cross-member ropes 2 are advantageously provided in each of the four faces of the truncated pyramid structure, when it is deployed.

At the desired moment and location, the three-dimensional lattice of this structure, kept in the flexible state and folded in the closed container 4-5, of reduced volume compared with the deployed structure, is deployed and tensioned by the gradually inflated gas bag 3, for example by a remote control, after releasing, also by a remote control, the cover 5 with respect to the trunk 4, this gas bag 3 forming a deployment device or expander, after which hardening of the ropes 1 and 2 takes place by exposure to an agent which hardens the resin impregnating the ropes, for example by the action of the ambient atmosphere, heat, humidity or by controlling an auxiliary system producing the agent which hardens the resin impregnating the ropes 1 and 2.

This auxiliary system can be a lighting system emitting ultraviolet radiation, if the resin is sensitive to this radiation for its polymerization and hardening, or a system emitting thermal radiation and possibly an electrically powered system for heating conducting filaments combined with the fibers forming the ropes 1 and 2.

The inflatable gas bag 3, which forms the deployment device or extension system for the structure, is independent of the rigging mesh 1-2 of the structure and expands the ropes 1 and 2 and the combined rigging mesh, and keeps this mesh and the ropes forming it in the taut state during hardening of the impregnating resin.

The first step of creating such a structure is production of the rigging, which is of no particular problem. The ropes 1 and 2 can effectively be produced from any existing fibers, of which the most frequently used for producing pre-impregnated rovings, commonly used to form composite materials especially in aeronautics, are mineral fibers, such as carbon or glass fibers, organic or synthetic fibers, such as aramid fibers, polyamide or polyester fibers and also artificial fibers made from plant fibers or by combination or mixing of fibers of various types. Because of its impregnation with a hardening material such as a polymerizable resin, the rigging of the structure is a composite rigging, kept flexible as long as the impregnating resin is not polymerized, then hardened and rigidified, after deployment of the rigging and whilst it is kept deployed and taut, by polymerizing the resin triggered by exposure of the rigging to an agent suitable for hardening or polymerizing the resin according to the nature of this resin.

Three-dimensional lattice structures comprising at least one rigging mesh, similar to the one described above, can be created in many different shapes, the latticed structure being initially defined on an accurate template of the desired shape, by selection of the number, dimensions, cross-sectional shapes and the type of the various ropes used, whose tension is monitored, as well as by production of the links between the ropes, possibly of some ropes with themselves at various points and, finally, with possible rigid elements of the structure, such as the container and its cover, or any other supporting base or platform of the structure.

The advantage of such a structure resides in its lightness, simplicity, the low cost of its constitutive materials and of the labor required for its production.

Preferably, installation of the deployment device such as the inflatable gas bag 3 or possibly a pressure cylinder or a hinged mechanism, for example a deformable parallelogram, or an elastic expander or even stays or a combination of these various means, can be performed after dimensional control of the rigging structure following its assembly on a template, as far as a deployment device is necessary, because deployment can possibly be manually ensured.

Once deployed and rigidified, the structure corresponds to a more or less complex structural frame composed of connecting rods or beams of composite material and such that the deployment device can, if necessary, be removed or retracted (for example, deflated) after rigidifying the deployed structure by hardening of the impregnating resin, because this structure can be independent, totally or at least at the ropes 1 and 2, of said deployment device.

This hardening can be that of a resin reacting with the surrounding environment, in particular, ultraviolet radiation of solar origin, the ambient temperature or humidity, etc. Hardening can also be commanded by the addition of an ultraviolet lamp inside the structure or, as already referred to above, by heating filaments embedded in each rope to be rigidified. The addition of a device, which produces the hardening agent for the resin, is advantageous in cases in which the structure, deployed and rigidified in its final usage configuration, must be at least partially enclosed in a cover, which is opaque or impermeable to the hardening agent. However, in all embodiments of such a structure, it is essential that the start of hardening can be controlled and suited to or suitable for the ambient conditions prevailing on the deployment site for each structure considered.

The method described above for creating and implementing a deployable light structure capable of being rigidified after deployment according to the invention is equally suitable for structures used in conditioning systems, which are rolled, folded or folded back onto themselves, or collapsed onto themselves before usage and, possibly, after a first usage and before a second usage, when the resin hardening phenomenon is reversible, for example when the resin is of thermoplastic type.

In an alternative embodiment, the structure in FIG. 1 described above comprises a protective jacket 30 enclosing the rigging 1-2, which can be hardened, and the gas bag 3 before and after their deployment, this protective jacket 30 being deployed simultaneously with the rigging 1-2 and the gas bag 3 and this jacket 30, similar to a sheath of approximately cylindrical shape but which can be of any shape, is linked by its ends to the base box 4 and to the platform or cover 5, whilst being independent of the deployment device composed of the inflatable gas bag 3. The jacket 30 fulfills several functions, such as thermal control and/or protection against radiation, meteorites and/or debris moving in space. This jacket 30 is, for example, of so-called MLI (Multi Layer Insulation) type.

To avoid impeding rigidification of the rigging 1-2 after its deployment by the gas bag 3, the jacket 30 can be manufactured such that it is transparent to the hardening agent, to which the resin impregnating the ropes 1 and 2 reacts, for example this jacket 30 can be transparent within the spectral range of solar radiation acting as hardening agent for a resin impregnating the ropes 1 and 2, in particular to ultraviolet radiation, such that the jacket 30 ensures a certain thermal stability of the mesh 1-2 after deployment.

A structure according to the invention has many advantages emerging from the simplicity and low cost of producing the basic material, namely the rope or ropes composing the rigging impregnated with resin. Depending on the envisaged application and, in particular, the environment in which the structure is intended to be deployed and rigidified and the forces which the deployed and rigidified structure is intended to resist, the rope or ropes used can be selected from products currently available on the market and offered by rope manufacturers or, conversely, be manufactured to order on one or several conventional rigging weaving machines in a particular fiber or in a particular combination of fibers, the fibers of each rope being grouped together, in a known way, in filaments, rovings and strands, which are arranged to form a single braided or woven rope or a laid rope or a rope with a core enclosed in a sheath. This core can be made of fibers, parallel filaments or strands, or can be a braided or woven core, whilst the sheath can itself be braided, woven or laid, or can be a sheath composed of a continuous film made of a synthetic material or of a sheet of synthetic material wrapped around the core and glued or welded to itself, such that the sheath retains the resin impregnating the core. When the sheath is itself woven or braided or laid, the constitutive fibers and filaments of the sheath are advantageously themselves impregnated with a resin hardening, for example, by polymerization, or possibly a thermoplastic resin, the advantage of woven or braided or laid configurations for both the core and the sheath of the rope being that these configurations encourage penetration of the resin into both the sheath and the core of the rope, which ensures more uniform rigidification of the rope and therefore a greater capacity for the latter and for the structure thereby formed to resist loads.

FIG. 2 illustrates diagrammatically, partly in lateral elevation and partly in cross section, a rope 1 or 2 in FIG. 1, whose core 7 is braided or woven from filaments, each filament being created by clustering fibers of a type selected according to the application, in other words according to the purpose of the deployed, rigidified structure, the filaments of the core 7 being impregnated with a resin hardening, for example, when it is exposed to ultraviolet radiation. The core 7 is enclosed in a continuous sheath 8 produced in the form of a synthetic film transparent to ultraviolet radiation, the rope composed of the core 7 and of the sheath 8 being enclosed in a sheath 9 made of a synthetic material also transparent to ultraviolet radiation and, possibly, thermo-shrinkable to tightly enclose the rope 7-8 and to ensure effectively its mechanical protection.

This sheath 9 can be easily made impervious, especially to allow the use of more or less liquid resins, which could be dried either by manipulation or by contact with the ambient atmosphere or by remaining for a period in a vacuum, in the case of application in space, and this sheath 9 facilitates moreover manipulation of the rope thereby produced. It is important to note that the imperviousness ensured by the sheath 9 with respect to the surrounding environment allows the expiration time of the rigging to be increased, in other words the period before the end of which the rigging must have been deployed and rigidified by hardening of the impregnating resin, otherwise the rigging is no longer suitable for rigidification because of aging and deterioration of the resin, it being possible for this expiration time to be reduced to a few months for a resin impregnating a rope kept in contact with the surrounding environment, for example in the open air, with no sheath such as the sheath 9 in FIG. 2.

In an alternative embodiment, this sheath 9 can also be made of sheets of a synthetic material wrapped around the rope, then glued or welded to themselves, instead of a continuous sheath made of synthetic material.

To allow hardening of the impregnating material to be commanded and controlled in the presence of such a sheath 9, this sheath 9 should of course be transparent to the hardening agent commanding hardening of the hardening material, such as the resin impregnating the rope, except if the hardening agent is produced by elements integrated into the rope, for example heating filaments, as referred to above.

FIG. 3 illustrates diagrammatically a link 6 between two sections of the same rope 1 or 2, as shown, for example, in FIG. 2, or of two different ropes 1 or 2, for example at a link 6 between a cross-member rope 2 and an upright rope 1 of the three-dimensional lattice structure in FIG. 1.

In the example in FIG. 3, the link 6 is created using a clamping collar 10, of electrical cable clamping collar type, which surrounds two locally deformed parts of the two ropes 1 and 2, which are in contact and overlapping one another, without destroying the protective sheath 9 of either of these ropes 1 and 2, around which the collar 10 forms a tie at a knot of the rigging mesh of the lattice in FIG. 1. We note that the collar 10 can be removed or moved during fabrication of the structure. This assembly process, which is very simple and reversible before hardening of the resin impregnating the ropes 1 and 2, offers the advantage that local deformations of the ropes 1 and 2 at their overlaps ensure a rigid link after hardening, for example by polymerization, of the resin.

If the link 6 in FIG. 3 forms a knot of the mesh of the lattice in FIG. 1, then we understand that the rope 2 can form, in succession, at least two inclined cross-members, each of which is linked, at its two ends, to the upright ropes 1 of the structure without it being necessary to cut ropes to the desired length to form each of the cross-members of this structure.

Similarly, fixing of the structure obtained on a bottom or fixing of an object, for example the cover 5 of the container 4, a cover that forms the platform of the deployed, rigidified structure, on the rigging structure can be achieved by simply gripping the ropes, possibly at their ends, for example between a plate and a base bolted towards each other, such that a section of the rope is held between them, to form a link arranged as a tightening nut. To facilitate holding of a section of rope, or its end, between a plate clamped against a base, it may be advisable to tie a knot in this section or at the end of the rope. Moreover, to attach a rope end to a support or to a supported part or to another rope, it may be advantageous to use a loop instead of a knot or a gripping device or in addition to the latter means.

The inventive process for creating a deployable light structure capable of being rigidified after deployment, as described above, and which comprises in general at least the steps involving impregnating one or more ropes of a rigging with a hardening material, whose hardening can be controlled, such as a polymerizable resin, creating a rigging structure of suitable shape for obtaining the required deployed, rigidified structure, in particular using a template of this required shape, selecting the number, shapes, dimensions, in particular of the cross section, of the ropes and of their relative positions, especially within a rigging mesh, thereby adjusting the spatial requirement, the stiffness and the mass of the required structure, then extending the rigging to the required shape before it is hardened, and keeping this rigging taut during its hardening, by exposing the taut rigging to at least one hardening agent of the hardening material impregnating the ropes, is a process, which can be used to create any conserved, and possibly transported, structure, occupying a reduced volume before its usage and thus its deployment and rigidification. It is therefore clear that this process can be implemented to create usual objects, to which their final shape and rigidity are given at the time when these objects have to be used for the first time.

In the space field, this process for creating such deployable light structures capable of being rigidified after deployment can be mainly implemented in three types of application: moving away and holding in position of objects with respect to a supporting base, rigidifying of a surface and rigidifying of deployable mechanisms.

Concerning the first type of application, three examples of implementation are diagrammatically illustrated in FIGS. 4, 5 and 6.

FIG. 4 illustrates, in a deployed position, a tripod composed of three upright ropes 1 of equal length, each fixed respectively by its bottom end at one of the three apexes of an equilateral triangle defined on a carrying base (not shown), and the top ends of which are fixed to the three apexes of a triangle on the bottom face of a circular disk 5′, forming a platform and surmounted by a rod 11 capable of supporting an effective load, for example a detector or optical device or a component of a telecommunication system. As in the example in FIG. 1, deployment of this simple structure can be ensured by inflating a substantially vertical cylindrical gas bag 3′, which is independent of the ropes 1 and which, in an inflated state, extends vertically upwards from the supporting base until it deploys and tensions to a maximum the ropes 1 and keeps the ropes 1 taut in this configuration, during hardening of the impregnating resin by exposure to a hardening agent appropriate to the application, for example light or ultraviolet radiation, or exposure to the ambient atmosphere, which can be the vacuum of space.

FIG. 5 illustrates partially an elongated beam also composed of a three-dimensional lattice, but, in this example, of constant area cross section and of triangular shape, defined by three longitudinal upright ropes 1 and inclined cross-member ropes 2 linking two ropes 1, as in the example in FIG. 1 and, in addition, triangular ribs or frames 12, pre-cut in a rigid material to give the assembly its triangular cross section and connected by links, such as the links 6 in FIG. 3, to the ropes 1 and possibly to some ropes 2, and within which a deployment device composed of an elongated inflatable gas bag 3, independent of the ropes 1 and 2, extends, when it is pneumatically inflated, to control deployment of the structure and then to keep the structure deployed during hardening of the resin impregnating the ropes 1 and 2.

FIG. 6 illustrates diagrammatically a tower formed by superposition of two stages, each of which is created by a three-dimensional lattice, the upper stage being inclined with respect to the longitudinal axis of the lower stage, for example, on the one hand, to move a component, such as an antenna, away from the body of a satellite and, on the other hand, to position the antenna outside the field of view of an optical component also mounted on the body of the satellite.

The first stage of the structure in FIG. 6 is composed of a structure similar to the one in FIG. 1, but asymmetrical, with the upright ropes 1a and certain inclined cross-member ropes 2a, whose bottom ends are directly attached to fixed points of a base 14, for example an external face of a satellite body, by links 6a similar to the aforementioned links 6, the top ends of the upright ropes 1a and the inclined cross-member ropes 2a being attached by similar links 6a to an intermediate platform 5a, when the first stage structure is deployed by inflating a first inflatable gas bag 13a, similar to the gas bag 3 in FIG. 1, and its longitudinal ends bear on both the base 14 and the bottom face of the intermediate platform 5a, being independent of this platform 5a and of the ropes 1a and 2a.

The second stage of this structure is substantially the same as the structure in FIG. 1 and is composed of upright ropes 1b, whose bottom ends are attached by links 6b, similar to the links 6 described above, to the top face of the intermediate platform 5a, whilst their top ends are attached by links 6b to the bottom face of a top platform 5b, the upright ropes 1b being tied and braced by inclined cross-member ropes 2b and by pre-cut rigid frames (similar to the frames 12 in FIG. 5) or cross-member ropes 12b extending substantially within normal cross sections of this second structural stage, in other words perpendicularly to its longitudinal axis, around a second inflatable gas bag 13b, which forms the deployment device of the second stage of this structure, and its longitudinal ends bear against the top face of the intermediate platform 5a and the bottom face of the top platform 5b, being independent of these platforms 5a and 5b and of the ropes 1b and 2b.

A two-stage structure of this type can be deployed either sequentially, one stage after the other, or simultaneously, or with an overlap, in which case the deployment of one stage starts before that of another stage has ended, since all lone ropes of the two rigging meshes used for the two stages of the structure are flexible and are only rigidified after deployment, whereas the two inflated gas bags 13a and 13b hold the deployed structure during the rigidification of the ropes by hardening the impregnation resin or resins.

FIG. 7 illustrates an example of an application of the aforementioned second type, namely rigidification of a surface, for example keeping extended a flat surface, which can be used as a solar screen, or a complex surface such as an antenna reflector.

As a deployment device, the structure comprises an inflatable extension gas bag 15 of approximately toric shape, on the one hand, at the end of both branches of a second V-shaped, inflatable extension gas bag 16, on the other hand, whose base 17, designed to be fixed to a support (not shown) on which this structure is intended to be deployed, corresponds to the point of convergence of several ropes 18, extending along the edges of a polygonal-based, for example hexagonal-based, pyramid bounded by other ropes 19 between which a reflecting shell 20 is fixed by its edges. Hangers 21, composed of lengths of cord not impregnated with a hardening material, give the shell 20 its particular shape, determined by the number and length of the hangers 21 and by the number and length of the ropes 18 and 19, which are impregnated with a hardening material, for example a polymerizable resin, and which form the structure capable of being rigidified of the assembly. After its rigidification, this structure capable of being rigidified 18-19 determines the required shape of the polygonal-based pyramid allowing the shell 20 to be deployed and extended and we understand that, in the application of this shell 20 to creating an antenna reflector, the shape-defining hangers 21 also allow the focal length of the reflector thereby created to be adjusted. For this purpose, it is advantageous for the hangers 21 to link each of the apexes of the polygonal base defined by the ropes 19 to a central point, linked by another hanger 21 to the point of convergence of the edge ropes 18, in other words to the base 17 of the V-shaped gas bag 16, at which the structure capable of hardening is attached to the supporting structure by the ends of the ropes 18, other hangers 21 being capable of linking, for example, the mid-point of each “radial” hanger 21 to the point of convergence of the ropes 18.

A braking system can be associated with the deployment device in order that the deployment of the rigging 18-19 and of the hangers 21 by inflation of the gas bags 15 and 16 independent of the rigging 18-19 is not too rapid and sudden to run the risk of tearing the shell 20 or of detaching a part of its periphery from the edge ropes 19. For example, small springs (not shown) can be mounted along certain ropes 18 and 19 such that these springs are loaded by deployment and extension of the ropes 18 and 19 under the action of inflation of the gas bags 15 and 16, and such that this spring load ensures braking of the deployment, limiting the deployment speed, and therefore, at the end of travel, the forces exerted on the connecting points between the shell 20 and the edge ropes 19.

As in the example in FIG. 1, the whole of the rigging 18-19 in FIG. 7, before its deployment, and the deflated gas bags 15 and 16, the shell 20, the braking system, if required, and possibly also a hardening agent control and/or production system, for example an ultraviolet lamp, can be housed in a container, which is fixed to an external face of the body of the satellite and in which the rigging 18-19, the shell 20 and the hangers 21, as well as the deflated gas bags 15 and 16, are housed in a rolled state or folded back on themselves in the case of those elements, which are flexible or deformable before deployment and rigidification.

FIGS. 8a to 8c illustrate an example of an application of the aforementioned third type, in which a single rope impregnated with a hardening material (for example polymerizable resin) limits the degree of opening of a panel hinged on a support, then ensures immobilization of the panel with respect to the support, after hardening of the material impregnating the rope, which becomes a simple rigid connecting rod of fixed length.

Such a rigidifying connecting rod can be advantageously used on satellites to keep pivoting panels, such as solar or radiator panels, in a deployed position.

Certain observation satellites are effectively required to change quickly their attitude, on either side of their paths, to be able to photograph various regions of the land surface during the same orbit. The faster the change in attitude of such, so-called agile, satellites, the higher the natural frequencies of the various appendages possessed by these satellites must be, to prevent them going into resonance and causing oscillations of the satellite.

But, the solar panels, with which these satellites are usually equipped, have large surface areas and are critical appendages. They are usually made of sandwich panels to reduce their mass and are hinged on the body of the satellite, such that they are positioned along the body of the satellite for launching, to minimize the volume occupied beneath the nose cone of the launch rocket during placement in orbit. Once in orbit, these panels are deployed to adopt their operating position. Their lightness, resulting in certain flexibility, dictates the use of reinforcing connecting rods or torque links between the body of the satellite and the end of the panels, and whose effect is to increase the natural frequency of these panels.

Use of a deployable light structure capable of being rigidified after deployment, according to the invention, simply composed of a single rope, capable of being rigidified, allows production and mounting of such connecting rods to be simplified, based on simple economic means.

FIG. 8a illustrates diagrammatically the body 22 of a satellite, on which a panel 23, such as a solar or radiator panel, has been mounted to pivot about a drive hinge 24, possibly braked to limit the pivoting speed, and extending, for example, along parallel contiguous edges of the panel 23 and of the body of the satellite 22 (which are bottom edges in FIG. 8a), and FIG. 8b illustrates the panel 23 during pivoting, through and about the drive hinge 24, towards its deployed position, shown in FIG. 8c, in which the deployed panel 23 is substantially perpendicular to the folded position, which it occupied in FIG. 8a, and is connected to the body 22 of the satellite by a single rope 25, capable of being rigidified and impregnated with a polymerizable resin, as yet nonpolymerized and therefore flexible, which does not resist the pivoting of the panel 23, but limits this pivoting when the rope 25 is taut, as shown in FIG. 8c. In this latter position, the rope 25 is exposed to a hardening agent, for example the ultraviolet spectrum of solar radiation, such that the impregnating resin is polymerized and the rope 25 is rigidified into a bracing connecting rod for the deployed panel 23.

To ensure that the impregnated rope 25 remains flexible at the moment of deploying the panel 23, this rope 25 is attached by its two ends, on the one hand, to the body 22 and, on the other hand, to the panel 23 at fixed points inside a protective frame 26a, on the body 22 of the satellite, and 26b, on the internal face of the panel 23 (the face directed towards the body 22 in the folded position of the panel 23), respectively, such that these two frames 26a and 26b close onto each other to form a box totally enclosing the impregnated rope 25, in a flexible state, to conceal it from the hardening agent as long as deployment by pivoting the panel 23 through the drive hinge 24 has not been commanded. In other words, the frames 26a and 26b form a protective baffle preventing exposure of the flexible rope 25, folded inside these frames, to ultraviolet radiation in the position in which the panel 23 is folded against the body 22. Once deployed and exposed to solar radiation, the rope 25 rigidifies, which has the effect of preventing any rotation either of its ends or of its central part.

Prior to rigidification, fixing of the rope 25 at its two ends, conserving the flexibility required for it to serve as a rotational joint at these ends and in its central part, can be ensured, as illustrated in the enlarged, circled detail in FIG. 8c, using a tightening nut 27 comprising a base 27a screwed against the body 22 of the satellite and a tightening plate 27b, which is tightened towards the base 27a by virtue of mounting and tightening bolts 28, by gripping one end of the rope 25 in opposite recesses formed in the plate 27b and the base 27a, a knot at the end of the rope 25 being possibly held on the other side of the tightening nut 27 to prevent any untimely release of the rope 25.

A similar fixing can be used to attach the other end of the rope 25 to the panel 23. The fixed points for attaching the ends of the rope 25 to the body 22 and especially to the deployable panel 23 are chosen such that the vibration mode frequencies of the panel 23, held deployed with respect to the body 22 when the single rope 25 is rigidified into a rigidifying connecting rod, are greater than a required frequency threshold.

In this embodiment, the deployment device for the rope 25 capable of being rigidified is effectively the deployable panel 23 itself, whose deployment actuator is represented by the drive hinge 24.

The hardening agent is not limited to the ultraviolet spectrum of solar light, but the rope 25 capable of being rigidified can comprise, as described in the preceding examples, heating filaments to ensure rigidification by heat input, or a system generating the hardening agent can be installed inside the body 22 of the satellite and operated after extension of the rope 25 to cause hardening of the latter.

In an alternative embodiment, the hinge 24 may not be a drive hinge and deployment of the panel 23 may be controlled by one or more actuators independent of both the hinge 24 and the rope 25, for example pyrotechnical means associated with one or more springs, for example torsion springs, at the hinge 24 connecting the panel 23 to the body 22 of the satellite.

The examples described above show that the deployable light structure, capable of being rigidified after deployment, according to the invention, has the following main advantages.

Any structural shape can be easily created, especially on a template, without complex working of the material or materials used, such as cutouts, seams, etc.

The accuracy of the structural shape is imposed by the elasticity of the ropes and their triangulation (mesh), independently of the deployment device, and this accuracy can be checked using a template.

The structures obtained can range from a simple connecting rod, as in the example illustrated in FIGS. 8a to 8c, to extremely complex three-dimensional lattices (see, for example, FIGS. 1, 5 and 6).

Use of any hardening resin, sensitive to light, ultraviolet rays and/or thermal radiation, in particular, and any fiber is possible.

In addition to the impregnated rigging capable of being rigidified, the deployable structure can comprise mechanical elements, such as platforms, frames or pods, for fixing equipment or for local positioning accuracy.

Any impregnated rigging rope can receive an impervious sheath, facilitating its handling, making it insensitive to certain external aggressive effects and prolonging its lifespan before hardening.

The deployment device or expander is independent of the impregnated rigging and can possibly be integrated into the structure after production of the impregnated rigging.

In the case of extension of the structure by inflating at least one gas bag, the latter remains of simple structure, even for a complex deployable structure, and can be easily created by current methods requiring no development.

The deployment device or expander can easily be doubled, such that a certain redundancy is ensured, because of its independence with respect to the rest of the structure and, in particular, the impregnated rigging. The rigidity of the structure rigidified after deployment can be adjusted by the quantity, directions, cross section or cross sections and the type of the fibers of the ropes of the rigging, possibly a lattice, as is the case in a structural lattice frame.

In the case of lattice structures, mathematical modeling of the structure is simplified once the characteristics of the beams and nodes are known.

Finally, deployment and possible folding back of the structure are simplified and can be independently performed on the structure without a deployment device, on the deployment device or devices, or on both at the same time, by allowing testing on the ground.

1. A deployable light structure capable of being rigidified after deployment, characterized in that it comprises a rigging (1-2, 1a-2a, 13-25-12b, 18-19, 25) composed of at least one flexible rope (1, 2, 1a, 1b, 2a, 2b, 18, 19, 25) impregnated with a hardening material, whose hardening can be controlled, designed to rigidify said at least one rope after its deployment and extension, and in that it is independent of any means of deployment (3, 3′, 13a-13b, 15-16) designed to extend at least one rope (1, 2, 1a, 1b, 2a, 2b, 12b, 18, 19) of the structure and to keep it taut during hardening of said hardening material.

2. The structure as claimed in claim 1, characterized in that it comprises at least one rigging mesh (1-2, 1a-2a, 15-25-12b), of which at least one flexible rope (1, 2, 1a, 1b, 2a, 2b, 12b) is impregnated with said hardening material and linked to itself and/or to at least one other rope of said rigging by at least one link (6, 6a, 6b).

3. The structure as claimed in any one of claims 1 and 2, characterized in that it also comprises at least one deployment device (3, 3′, 13a-13b, 15-16) independent of the rigging and designed to extend at least one rope (1, 2, 1a, 1b, 2a, 2b, 12b, 18, 19) of the structure and to keep it taut during hardening of said hardening material.

4. The structure as claimed in claim 1, as related to claim 2, characterized in that said deployment device (3, 3′, 13a, 13b, 15-16) is designed to deploy then keep said at least one rigging mesh (1-2, 1a-2a, 1b-2b-12b, 18-19) taut during its rigidification.

5. The structure as claimed in any one of claims 1 to 4, characterized in that said rigging is composed of at least one type of fiber selected from mineral, such as glass or carbon, and synthetic or organic, such as polyester or polyamide, and aramid and artificial fibers.

6. The structure as claimed in claim 5, characterized in that at least one rope of said rigging is a composite rope comprising fiber rovings pre-impregnated with a resin capable of being rigidified.

7. The structure as claimed in any one of claims 1 to 5, characterized in that at least one of the ropes (1, 2) of said rigging is of one of the following types: single braided or woven rope, laid rope, rope with a core (7) enclosed in a sheath (9), rope with a braided or woven core (7), rope with parallel fibers or strands and/or rope with a braided or woven or laid sheath.

8. The structure as claimed in any one of claims 1 to 7, characterized in that at least one rope (1, 2) of said rigging is enclosed in an impervious sheath (9) of at least one of the following types: a continuous sheath made of synthetic, preferably thermosetting, material and a sheath made of a sheet of synthetic material wrapped around said rope (1, 2), then glued or welded to itself.

9. The structure as claimed in any one of claims 1 to 8, characterized in that said hardening material reacts with at least one of hardening agents selected from the group comprising light radiation in visible or ultraviolet light, thermal radiation, temperature, humidity, ambient atmosphere and vacuum.

10. The structure as claimed in any one of claims 1 to 9, characterized in that at least one rope (1, 2, 25) of the rigging incorporates a heating element, preferably a heating filament, whose heating controls the hardening of the hardening material impregnating said rope.

11. The structure as claimed in claim 8, characterized in that at least one rope (1, 2) of said rigging incorporates an impervious sheath (9) transparent to a hardening agent controlling the hardening of the hardening material impregnating said rope (1, 2), in particular, an impervious sheath made of synthetic material transparent to ultraviolet radiation.

12. The structure as claimed in any one of claims 2 to 11, characterized in that said link (6), by which at least one rope (1, 2) of said rigging is linked to itself or to at least one other rope of said rigging, is composed of at least one of the following means: a knot, a tie, a clamping collar (10), by gripping or binding of two sections of the rope (1, 2) at their linkage location.

13. The structure as claimed in any one of claims 1 to 12, characterized in that at least one rope (1, 2, 25) of said rigging is attached at one end by at least one of the following means: a loop, a knot and by gripping (27).

14. The structure as claimed in any one of claims 1 to 13, characterized in that the cross section of at least one rope (1, 2, 18, 19, 25) of said rigging is adjusted in shape and/or dimension according to the desired properties of the rigidified structure, in particular, its mass, its spatial requirement and its stiffness.

15. The structure as claimed in any one of claims 1 to 14, characterized in that it comprises additionally a protective jacket (30) enclosing said rigging (1-2) before its deployment and deployed simultaneously with said rigging, said protective jacket (30) being independent from the deployment device (3), if need be.

16. The structure as claimed in claim 15, characterized in that said protective jacket (30) ensures at least one of the following functions: thermal control, anti-meteorite, anti-debris and anti-radiation protection.

17. The structure as claimed in any one of claims 15 and 16, characterized in that said protective jacket (30) is transparent at least to the spectral range of solar radiation acting as hardening agent for the hardening material impregnating at least one rope (1, 2) of said rigging.

18. The structure as claimed in any one of claims 1 to 17, characterized in that the deployment device comprises at least one of the following means: an inflatable gas bag (3, 3′, 13a, 13b, 15-16), a pressure cylinder, an elastic expander, a hinged mechanical device and a stay.

19. The structure as claimed in any one of claims 1 to 18, characterized in that it incorporates additionally a braking system designed to limit at least the deployment speed during deployment.

20. The structure as claimed in any one of claims 1 to 19, characterized in that the whole of the rigging (1-2), before its deployment, and, if required, the deployment device (3), the protective jacket (30), the braking system, and possibly also at least one hardening agent control and/or production device as well as at least one thermal control device, are housed in a container (4-5), in which said rigging is arranged in the rolled, folded or collapsed state.

21. The structure as claimed in claim 20, characterized in that said container (4-5) comprises at least one cover (5) forming a support erected above at least one base trunk (4) of said container, when said structure is deployed and rigidified.

22. An application of the structure as claimed in any one of claims 1 to 21, characterized in that said structure (18-19-15-16-20-21, 25) is installed aboard a spacecraft (22).

23. The application as claimed in claim 22, characterized in that said rigidified structure forms at least one rigidifying connecting rod (25) of a moveable solar or radiator panel (23) of a spacecraft, said structure comprising at least one rope (25) attached at one end to the body (22) of said spacecraft and at the other end to a fixed point of said moveable panel (23), said fixed point being chosen such that the vibration mode frequencies of said panel (23), kept deployed with respect to the body (22) of the spacecraft, when said rope is rigidified to form a rigidifying connecting rod, are greater than a desired frequency threshold, said panel (23) being moveable with respect to the body (22) of the spacecraft between a folded back position, in which the panel (23) extends substantially along the body (22) of said spacecraft and in which said rope (25) is protected (26a, 26b) from any hardening agent likely to cause hardening of said impregnating hardening material, and a deployed position, in which said panel (23) is moved away from said body (22) of the spacecraft by at least one actuator (24), and that the rope (25), after its deployment through deployment of said panel (23), rigidifies under the effect of at least one hardening agent, such as natural solar radiation, heating by a dedicated heating device internal or external to the rope (25) or a dedicated lighting device emitting light to cause rigidifying of the hardening material, particularly a polymerizable resin reactive to monochromatic light.

24. A process for producing a deployable light structure capable of being rigidified after deployment as claimed in any one of claims 1 to 21, characterized in that it comprises at least the steps consisting in:
impregnating at least one rope (1, 2, 1a, 1b, 2a, 2b, 12b, 18, 19, 25) of a structural rigging with a hardening material, whose hardening can be controlled,
creating a rigging structure of a shape suitable for providing the desired deployed and rigidified structure, preferably using a template of the desired shape, by choosing the number, the dimensions and the shapes of the relative positions of the ropes of said rigging, if necessary, of the rigging mesh or meshes (1-2, 1a-2a, 1b-2b-12b, 18-19),
extending said rigging into the desired shape before its hardening, and
keeping said rigging taut during its hardening by exposure of said taut rigging to at least one hardening agent for said hardening material impregnating the ropes.
